(19) United States
(12) Patent Application Publication
(10) Pub. No.: US 2019/0379212 A1
(43) Pub. Date: Dec. 12, 2019

(54) METHOD FOR CHARGING BATTERY INCLUDED IN ROBOT AND APPARATUS THEREOF

(71) Applicant: LG ELECTRONICS INC., Seoul (KR)

(72) Inventors: Youngkyu CHO, Seoul (KR); Sunok KIM, Seoul (KR); Jaemin PARK, Seoul (KR); Youngjung SUH, Seoul (KR); Byounggyo AHN, Seoul (KR)

(73) Assignee: LG ELECTRONICS INC.

(21) Appl. No.: 16/550,852

(22) Filed: Aug. 26, 2019

(30) Foreign Application Priority Data
Jul. 2, 2019 (KR) 10-2019-0079538

(51) Int. Cl. H02J 7/00; B60L 53/62; G06N 3/08; B60L 58/12

(52) U.S. Cl. CPC H02J 7/007; B60L 58/12; G06N 3/08; B60L 53/62

(57) ABSTRACT

A battery in a robot may be charged by a specific method. The method may include determining a battery charge amount to be charged to the battery based on an operation to be performed by the robot, determining a charging time for the battery based on the determined battery charge amount, determining a charging start time based on the charging time and a next operation start time of the robot, and starting charging of the battery at the charging start time.

### CROSS-REFERENCE TO RELATED APPLICATION

This application claims the benefit of Korean Patent Application No. 10-2019-0079538, filed Jul. 2, 2019 in Korea, in the Korean Intellectual Property Office, the disclosure of which is incorporated herein in its entirety by reference.

### BACKGROUND

### Field

The present disclosure relates to a robot capable of efficiently performing repeated battery charge and discharge processes.

### Background

Various industrial robots for use in medical, aerospace, shipbuilding, and agricultural industries, for example, have been manufactured and operated. Recently years, common household robots have been developed, and robot control and manufacture technologies are evolving to enable implementation of predetermined operations using such household robots.

A representative example of the household robots is a robot cleaner, which is a type of household appliance that sucks and cleans dust or foreign substances therearound via self-driving in a certain area. Unlike a disadvantageous stick-type vacuum cleaner in which a user performs a cleaning operation, the robot cleaner may automatically start and end cleaning. Therefore, such a robot cleaner is wirelessly movable by having a rechargeable battery, which is generally not a wired type.

Accordingly, such a rechargeable battery, which may be referred to as a secondary battery, may need to repeatedly perform charge and discharge process, and a reduction in lifespan of the battery or aging thereof in this process may be inevitable.

In an example of a robot that is automatically operated, when it is determined that an operation has been completed or when the remaining amount of power of a battery is reduced to a predetermined value or less, the robot returns to a charging station and immediately starts a charge process. Once the charge process has been started, the charge process may be continuously performed until a next operation is started. As a result, charging is continuously performed in a fully charged state (i.e., the state in which SoC is 100%) and the robot may always start a next operation from the fully charged state. However, such a charge method may be detrimental to lifespan of a secondary battery and may cause a rapid reduction in the lifespan of the battery.

The document entitled “Impact of dynamic driving loads and regenerative braking on the aging of lithium ion batteries in electric vehicles (by P. Keil, A. Jossen in Journal of The Electrochemical Society, 2017), discusses that the aging of a lithium ion battery includes usage-dependent cycle aging and usage-independent calendar aging, and that the lithium ion battery should not have a high SoC corresponding to a low anode potential.

In this way, when available power of a secondary battery included in a household or industrial robot falls below a certain level due to aging, a user may need to pay costs for increasing available time of the robot to replace the degraded battery with a new battery.

The price of the secondary battery may rapidly increase in proportion to capacity of the battery, and recent household robots have required an increased capacity of a battery inserted therein in order to perform various operations, and therefore, have been faced with an increase in replacement cost of the battery.

### BRIEF DESCRIPTION OF THE DRAWINGS

Embodiments may be described in detail with reference to the following drawings in which like reference numerals refer to like elements, and wherein:

FIG. 1 illustrates a process in which various types of wireless robots perform an operation and then are recharged in an operating environment according to an embodiment;

FIG. 2 illustrates a block diagram illustrating correlation between a robot, which is capable of charging a battery discharged by implementation of an operation, and a charging station according to an embodiment;

FIG. 3 illustrates a process of performing a battery charge method in a time sequence according to an embodiment;

FIG. 4 is a flowchart illustrating a process of performing a battery charge method according to an embodiment;

FIG. 5 is a flowchart illustrating a process of determining a current average power consumption based on a power consumption for a current operation and a previous average power consumption, which is the average of the amount of power consumed for previous operations in order to determine a required amount of power caused by the current operation according to an embodiment;

FIG. 6 is a flowchart of determining a charge rate of a battery based on a battery charge amount and a remaining amount of power of the battery and determining a charging time for the battery based on the determined charge rate according to an embodiment;

FIG. 7 is a graph illustrating a relationship between a charging time and an amount of power or between a charging time and an open circuit voltage (OCV) according to an embodiment;

FIG. 8 is a flowchart of a battery charge method for determining a charging time suitable for an operating environment using an artificial neural network, which has performed machine learning based on a battery charging result, when the battery charge method is performed next according to an embodiment;

FIG. 9 illustrates an AI device according to an embodiment;

FIG. 10 illustrates an AI server according to an embodiment; and

FIG. 11 illustrates an AI system according to an embodiment.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Embodiments of the present disclosure may be described in detail with reference to the drawings so that those skilled in the art can easily carry out the present disclosure. The present disclosure may be embodied in many different forms and is not limited to the embodiments described herein.

With respect to constituent elements used in the following description, suffixes “module” and “unit” are given or mingled with each other only in consideration of ease in the preparation of the specification, and do not have or serve as different meanings.

In order to clearly describe the present disclosure, elements having no connection with the description may be omitted, and the same or extremely similar elements are designated by the same reference numerals throughout the specification. In addition, some embodiments of the present disclosure will be described in detail with reference to exemplary drawings. When adding reference numerals to constituent elements of the respective drawings, it should be noted that the same or similar elements are denoted by the same reference numerals even though they are depicted in different drawings. In addition, in the following description of the present disclosure, a detailed description of known functions and configurations incorporated herein will be omitted when it may make the subject matter of the present disclosure rather unclear.

In addition, it will be understood that the terms first, second, A, B, (a), and (b), for example, may be used herein to describe various elements according to the embodiments of the present disclosure. These terms are only used to distinguish one element from another element and, thus, are not intended to limit the essence, order, sequence, or number of elements. It will be understood that, when any element is referred to as being “connected to” “coupled to”, or “joined to” another element, it may be directly on, connected to or coupled to the other element or intervening elements may be present.

It will be further understood that the terms “comprises” “comprising” “includes” and/or “including” when used in this specification, specify the presence of stated features, integers, steps, operations, elements, and/or components, but do not preclude the presence or addition of one or more other features, integers, steps, operations, elements, and/or components.

In addition, for convenience of description, the present disclosure may be embodied by subdividing constituent elements, but these constituent elements may be embodied in a single device or module, or one constituent element may be divided into multiple devices or modules.

Prior to describing various embodiments of the present disclosure, key terms may be described as follows. These descriptions are mere examples. Other descriptions may also be provided.

The term “robot” may refer to a machine that automatically operates or performs a given operation by abilities thereof. In particular, a robot that functions to recognize an environment and perform a motion based on self-determination may be referred to as an intelligent robot.

Robots may be classified into industrial, medical, household, and military robots, for example, according to purpose of use or field of use thereof.

The robot may include a drive unit (or driving device) including an actuator or a motor to perform various physical motions such as a motion of moving a robot joint arm. Additionally, a movable robot may include a wheel, a brake, or a propeller, for example, in the drive unit to travel on ground or fly in air via the drive unit.

The term “battery charge amount” may be the amount of power that a battery needs to be charged after a current operation and before the start of a next operation based on the result of calculating the amount of power that is expected to be needed for the next operation when the amount of power of the battery is reduced by an operation performed by a robot.

The term “charging time” may be an expected time required for charging a battery by a battery charge amount, which is the amount of power that a robot needs to charge before the start of a next operation. The charging time may vary based on the ambient temperature of a battery to be charged and the remaining amount of power of the battery, for example, even when the battery charge amount is consistent. According to an embodiment of the present disclosure, charging is performed only for the charging time from the time at which charging is started.

The term “operation start time” may be a time at which an operation performed by a robot is started. According to one embodiment, the operation performed by the robot may be a periodic operation (i.e., an operation performed at a predetermined time interval). According to another embodiment, when an operation is performed by a user, a time at which an operation is expected to be started may be determined and utilized as the operation start time. The time at which the operation is expected to be started may correspond to an average operation start time determined based on a cumulative operation start time. According to an embodiment, the operation start time of the present disclosure may also be a time point at which a charging time has passed from a charging start time.

The term “charging start time” may refer to a time at which a battery of a robot starts to be charged, and may correspond to a time at which the battery may be charged by a battery charge amount before a next operation start time. According to an embodiment, the charging start time may be different from a time at which a robot docks with or is connected to a charging station. That is, a time at which power starts to be supplied from a power supply unit (or power supply) included in charging station may be the charging start time.

The term “average power consumption” may be the average of the amount of power consumed in respective operations which are repeatedly performed by a robot. A previous average power consumption, which is determined based on information accumulated whenever an operation is performed, may be updated based on the amount of power consumed in a current operation, and a current average power consumption may be determined as an update result. The current average power consumption may be utilized as the previous average power consumption after a next operation is performed.

The term “cumulative amount of charge current” may be a cumulative amount of current introduced into a battery of a robot during charging, and the term “cumulative amount of discharge current” may be defined as a cumulative amount of current discharged during an operation performed by the robot. According to an embodiment, the cumulative amount of discharge current may be less than the cumulative amount of charge current, and a factor corresponding to the ratio of the cumulative amount of charge current to the cumulative amount of discharge current may be utilized in a process of determining a battery charge amount of the battery.

The term “charge rate” may be the rate of an increase in the amount of power of a battery of a robot during charging. The charge rate may vary based on a “charging profile”. The charging profile may include a constant current charge method in which the amount of power linearly increases and a constant voltage charge method in which the amount of power increases exponentially, and the robot may perform charging using at least one of the two methods.

The term “the remaining amount of power” is the amount of power still remaining in a battery, and may be determined based on the correlation between an open circuit voltage and the remaining amount of power. According to an embodiment, the open circuit voltage may be measured by measuring the voltage of a stabilized battery after a predetermined time (for example, about 3 hours) has passed after the battery is deactivated. A relationship table indicating the correlation between the open circuit voltage and the remaining amount of power may be prepared in advance and may be used to determine the remaining amount of power. According to an embodiment, the relationship table indicating the correlation between the open circuit voltage and the remaining amount of power may be indicative of the correlation between ambient temperature of the battery and aging state of the battery.

The term “aging state information” may relate to the rate of the amount of currently chargeable power in a battery compared to an initial amount of chargeable power in the battery. The battery, which has been degraded due to repeated charge and discharge processes, may be charged with only a smaller amount of power than the initial amount of chargeable power. In this example, even if a user recognizes that the battery is fully charged, the amount of actually available power may be less than that in the initial state of the battery. According to an embodiment, when the aging state information indicates a critical value (for example, 0.8) or less, the battery may be considered to have reached the end of its lifespan.

The term “artificial Intelligence (A.I.)” may refer to the field of studying artificial intelligence or a methodology capable of making the artificial intelligence, and the term “machine learning” may refer to the field of studying methodologies that define and solve various problems handled in the field of artificial intelligence. The machine learning is also an algorithm that enhances performance for a certain operation through a steady experience with respect to the operation.

The term “artificial neural network (ANN)” may include an input layer and an output layer, and may selectively include one or more hidden layers. Each layer may include one or more neurons, and the artificial neural network may include a synapse that interconnects neurons. In the artificial neural network, each neuron may output the value of an activation function concerning signals input through the synapse, weights, and deflection thereof.

The artificial intelligence may refer to a general model for use in the machine learning, which is composed of artificial neurons (nodes) forming a network by synaptic connection and has problem solving ability. The artificial neural network may be defined by a connection pattern between neurons of different layers, a learning process of updating model parameters, and an activation function of generating an output value.

The model parameters may refer to parameters determined by learning, and include weights for synaptic connection and deflection of neurons, for example. Hyper-parameters may refer to parameters to be set before learning in a machine learning algorithm, and include a learning rate, the number of repetitions, the size of a mini-batch, and an initialization function, for example.

One purpose of learning of the artificial neural network is to determine a model parameter that minimizes a loss function. The loss function may be used as an index for determining an optimal model parameter in a learning process of the artificial neural network.

The machine learning may be classified, according to a learning method, into supervised learning, unsupervised learning, and reinforcement learning.

The supervised learning may refer to a learning method for an artificial neural network in the state in which a label for learning data is given. The label may refer to a correct answer (or a result value) to be deduced by the artificial neural network when learning data is input to the artificial neural network. The unsupervised learning may refer to a learning method for the artificial neural network in the state in which no label for learning data is given. The reinforcement learning may refer to a learning method in which an agent defined in a certain environment learns to select a behavior or a behavior sequence that maximizes cumulative compensation in each state.

The machine learning realized by a deep neural network (DNN) including multiple hidden layers among artificial neural networks may also be called deep learning, and the deep learning is a part of the machine learning. In the following description, the machine learning is used as a meaning including the deep learning.

The term “autonomous driving (or self-driving)” may refer to a technology in which a vehicle drives autonomously, and the term “autonomous vehicle” may refer to a vehicle that travels without a user's operation or with a user's minimum operation.

For example, autonomous driving may include all of the technology of maintaining the lane in which a vehicle is driving, the technology of automatically adjusting a vehicle speed such as adaptive cruise control, the technology of causing a vehicle to automatically drive along a given route, and the technology of automatically setting a route, along which a vehicle drives, when a destination is set.

The vehicle may include all of a vehicle having only an internal combustion engine, a hybrid vehicle having both an internal combustion engine and an electric motor, and an electric vehicle having only an electric motor, and may include not only an automobile but also a train and a motorcycle, for example.

The autonomous vehicle may be seen as a robot having an autonomous driving function.

The term “extended reality” (XR) is a generic term for virtual reality (VR), augmented reality (AR), and mixed reality (MR). The VR technology provides only a CG image of a real-world object or background, for example, the AR technology provides a virtual CG image over an actual object image, and the MR technology is a computer graphic technology of providing an image obtained by mixing and combining virtual objects with the real world.

The MR technology may be similar to the AR technology in that it shows a real object and a virtual object together. However, the virtual object may be used to complement the real object in the AR technology, whereas the virtual object and the real object may be equally used in the MR technology.

The XR technology may be applied to a head-mounted display (HMD), a head-up display (HUD), a mobile phone, a tablet PC, a laptop computer, a desktop computer, a TV, and a digital signage, for example, and a device to which the XR technology is applied may be referred to as an XR device.

Various embodiments of the present disclosure may be described with reference to the drawings.

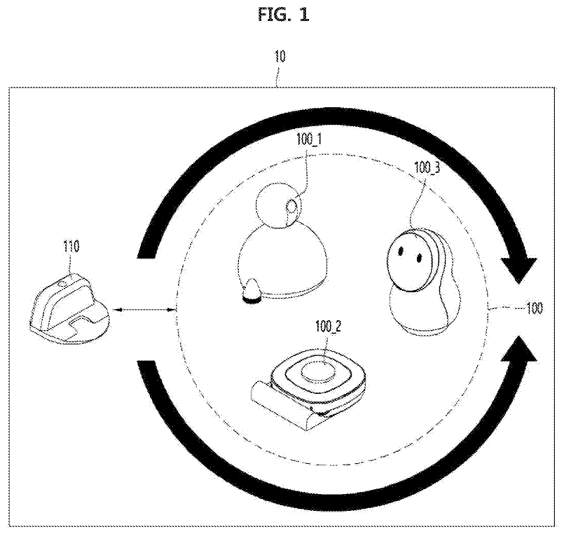

FIG. 1 illustrates a process in which various types of wireless robots perform an operation and then are recharged in an operating environment 10 according to an embodiment. Other embodiments and configurations may also be provided.

A household or industrial robot may perform a predetermined operation in various environments. Robot 100 for use in various fields (for example, 100_1, 100_2, and 100_3, hereinafter designated by 100 for ease of description) may perform an operation wirelessly, and thus may be advantageously capable of performing the operation while freely moving in operating environment 10, but needs to be repeatedly charged. Therefore, robot 100 may receive power by moving to a charging station 110 capable of supplying power for charging so as to restart an operation. Charging station 110 may be included in the operating environment in which the robot operates or may be located adjacent to the operating environment. When it is determined that robot 100 has completed the operation or that the remaining amount of power is small and the supply of power is required, robot 100 may easily and automatically move to charging station 110 to receive power from the power supply unit included in charging station 110, or may be manually powered off by a user to receive power from charging station 110.

In disadvantageous arrangements, it may be necessary to continuously supply power immediately after robot 100 moves to charging station 110 so as to dock with or be connected to charging station 110 for charging until robot 100 is removed from the power supply unit to start a next operation, which may cause rapid aging of a battery. Embodiments of the present disclosure may prevent aging of the battery by a method of charging the battery of robot 100 in the operating environment.

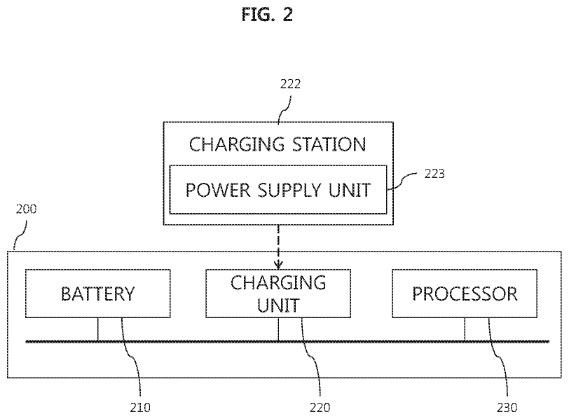

FIG. 2 is a block diagram illustrating correlation between a robot, which is capable of charging a battery discharged by implementation of an operation, and a charging station according to an embodiment. Other embodiments and configurations may also be provided.

According to an embodiment, robot 200 and charging station 222 of FIG. 2 may correspond to robot 100 and charging station 110 of FIG. 1.

Referring to FIG. 2, robot 200 may include battery 210 capable of supplying power required for various constituent elements included in robot 200, a charging unit 220 (or charger) configured to charge the battery by supplying power supplied from a power supply unit 223 (or power supply device) to battery 210, and a processor 230 capable of controlling operations of the constituent elements included in robot 200.

According to an embodiment, battery 210 may be a secondary battery that is rechargeable after discharge. Battery 210 as used in the present disclosure may include any one of various types of rechargeable secondary batteries including a lithium ion battery, a nickel hydride battery, and a nickel cadmium battery, for example.

According to an embodiment, charging unit 220 (or charging device) may charge battery 210 upon receiving power from power supply unit 223. According to an embodiment, a connection relationship between power supply unit 223 and robot 200 for supplying the power from power supply unit 223 to battery 210 via charging unit 220 may be realized in a wired manner using a power line, but may also be realized in a wireless charging manner.

According to an embodiment, processor 230 may control constituent elements included in robot 200 to realize various embodiments which may be implemented by various constituent elements included in robot 200. That is, in various embodiments which may be described below, an operation of robot 200 may be understood as being based on a control operation by processor 230. According to an embodiment, processor 230 may include at least one of a RAM, a ROM, a CPU, a graphic processing unit (GPU), and a bus, which may be interconnected.

Processor 230 may access a memory included in robot 200 and perform booting using an O/S stored in the memory. The processor 230 may then perform various operations using various programs, content, and data, for example, which are stored in the memory.

According to an embodiment, processor 230 may notify a user of the result of robot 200 performing a predetermined process of a battery charge method by controlling an output unit (or output device) to visually, acoustically, or tactually output the result of performing each step of the battery charge method performed by robot 200 according to the present disclosure.

Various operations which may be performed by robot 200 of FIG. 2 may be understood by those skilled in the art from the following various embodiments.

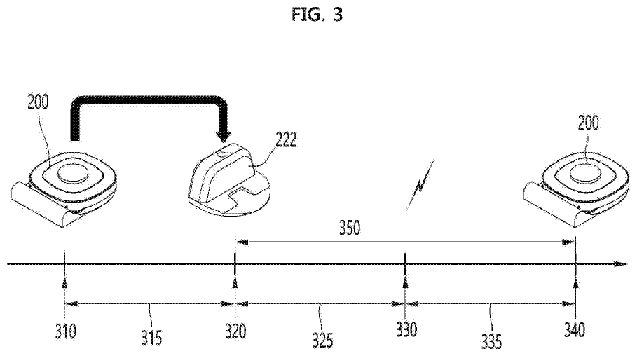

FIG. 3 illustrates a process of performing a battery charge method in a time sequence according to an embodiment. Other embodiments and configurations may also be provided. FIG. 3 shows a time point at which robot 200 returns to power supply unit 223 for charging battery 210 after performing an operation, a time point at which the robot starts to charge the battery for supplementing power exhausted by the operation, and a time point at which the operation is restarted after charging is completed by the charge method according to the present disclosure.

Referring to FIG. 3, robot 200 may start a first operation at a time point 310 and may perform the first operation during a first time 315. When a predetermined amount of power is consumed in the first operation, robot 200 may move to power supply unit 223 (included in charging station 222) to receive power so as to charge battery 210 at a first time point 320. The charging of battery 210 using power supply unit 223 may be a process of preliminarily supplying power to be used in a second operation, which is a next operation. Robot 200 may be continuously connected to power supply unit 223 until the second operation is started. Accordingly, in previous arrangements, the process of charging battery 210, which is performed after the first operation terminates, is started at first time point 320 and is to be continued until a second time point 340 at which the second operation is started. Accordingly, the longer a waiting time 350 between first time point 320 and second time point 340, the greater the remaining amount of power in battery 210 at second time point 340. Moreover, power may be continuously supplied to battery 210 for a long period of time even in a fully charged state, which may accelerate aging of battery 210.

According to the present disclosure, to prevent robot 200 from starting to charge the battery from first time point 320 at which robot 200 is connected to power supply unit 223, a charging start time 330, which is a time point at which charging is started after a predetermined time 325 has passed from first time point 320, may be determined, and a degree of charging required for battery 210 to perform the second operation may be determined, so that a charging time 335 may be determined. According to the present disclosure, by setting that charging start time 330 after first time point 320 and performing the charging process only just before second time point 340 at which the second operation is started, battery 210 may be prevented from being unnecessarily overcharged. That is, even if robot 200 moves to charging station 222 after a previous operation, robot 200 may not immediately charge battery 210 upon receiving power from power supply unit 223 (of charging station 222), but may be in a waiting state without charging for a predetermined time 325 may be in a waiting state while charging the battery with a smaller amount of power than the amount of power supplied during charging. By allowing robot 200 returned to charging station 222 to be in the waiting state for a predetermined time, the battery 210 may be prevented from being unnecessarily overcharged.

A detailed process may now be described of determining a battery charge amount, a charging time, a charging start time, and a charge rate, for example, which may be used for robot 200 to perform a battery charge method of the present disclosure.

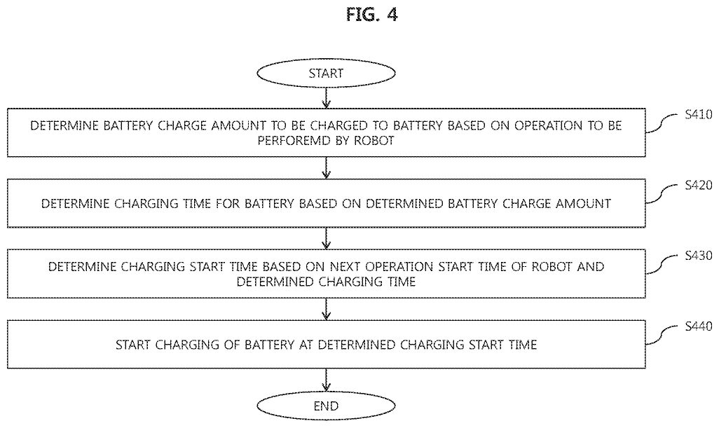

FIG. 4 is a flowchart illustrating a process of performing a battery charge method according to an embodiment. Other embodiments and configurations may also be provided.

Robot 200 may determine a battery charge amount to be charged to the battery based on an operation to be performed by robot 200 in step S410. According to an embodiment, the battery charge amount may be the amount of power that is expected to be required for a next operation based on the amount of power consumed in an operation completed before step S410 or a current ongoing operation. A process of determining the battery charge amount may be performed by robot 200 before a time at which charging is started based on the determined battery charge amount. For example, robot 200 may determine the battery charge amount at a time at which robot 200 is connected to power supply unit 223 after terminating the current ongoing operation, and/or may determine the battery charge amount after a predetermined time (for example, a time required to stabilize battery 210 or a time set by a user) has passed immediately from the end of the current operation. According to an embodiment, the process of determining the battery charge amount may be performed based on a previous charging start time. For example, robot 200 may perform step S410 at the previous charging start time or before a predetermined time from the previous charging start time.

According to an embodiment, robot 200 may determine the battery charge amount based on the remaining amount of power immediately before the completed operation is started. According to an embodiment, robot 200 may determine the battery charge amount for charging battery 210 with a substantially optimal amount of power, rather than charging battery 210 to a fully charged state. The battery charge amount may be the amount of power required for charging the battery with an optimal remaining amount of power, which may be determined in advance based on the operating environment of robot 200 and the ambient temperature of battery 210, for example. According to an embodiment, the optimal remaining amount of power may have a value preset by the user, may have a value determined based on information stored in advance in robot 200, and/or may have an optimal value automatically determined by robot 200.

In step S420, robot 200 may determine a charging time for the battery based on the battery charge amount determined in step S410 according to an embodiment. According to an embodiment, the charging time may be determined based on the remaining amount of power of battery 210. The charging time may be determined based on not only the remaining amount of power of battery 210 but also aging state information of battery 210. Thereby, a substantially required charging time may be determined based on the current state of battery 210.

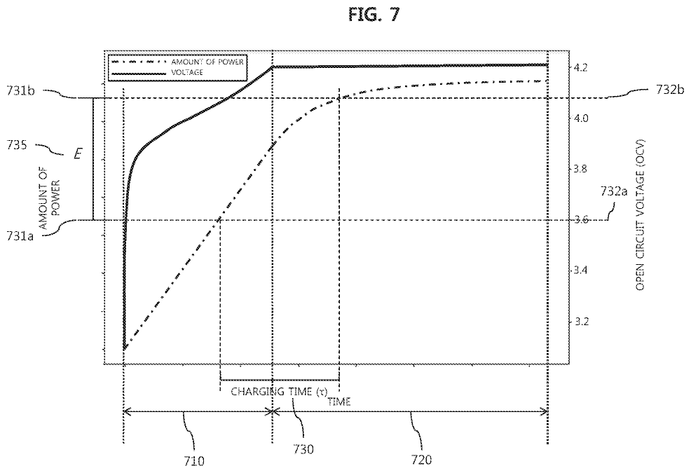

According to an embodiment, robot 200 may determine the charging time using a charge rate which varies based on a charging profile. According to an embodiment, the charging profile which may determine the charge rate may include a constant voltage charge method or a constant current charge method, and/or the constant voltage charge method and the constant current charge method may be used in combination during the charge process. A method of determining the charging time based on the charging profile may be described later with reference to FIG. 7.

In step S430, robot 200 may determine a charging start time based on the charging time determined in step S420 and a next operation start time of the robot 200 according to an embodiment. According to an embodiment, the charging start time may be determined by subtracting the charging time from the next operation start time, and in this example, robot 200 may terminate the charge process by starting a next operation. According to an embodiment, the charging start time may be determined by subtracting the charging time from a predetermined time point before the next operation start time.

According to one embodiment, at least some of the features of steps S410 to S430 may be determined before a predetermined waiting time until robot 200 starts charging. According to another embodiment, at least some of the features of steps S410 to S430 may be determined within a predetermined waiting time until robot 200 starts charging.

In step S440, robot 200 may start to charge the battery at the charging start time determined in step S430 according to an embodiment. That is, according to an embodiment, robot 200 may not receive power from power supply unit 223 for a time period from immediately after returning to charging station 222 to the charging start time, and may charge battery 210 using charging unit 220 which receives power from power supply unit 223 when the charging start time is arrived.

According to one embodiment, in the example in which robot 200 moved to charging station 222 waits at charging station 222 for a predetermined time before the charging start time, robot 200 may charge battery 210 based on a smaller amount of power than the amount of power supplied from power supply unit 223 during the charging time. According to another embodiment, in the example in which robot 200 moved to charging station 222 waits at charging station 222 for a predetermined time before the charging start time, robot 200 may not receive power from power supply unit 223. According to an embodiment, robot 200 may start charging after a predetermined time and may charge battery 210 until the next operation start time.

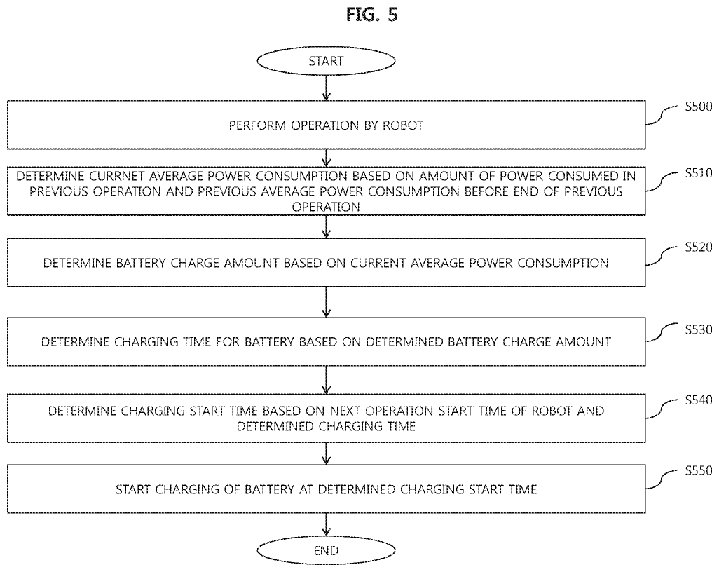

FIG. 5 is a flowchart illustrating a process of determining a current average power consumption based on a power consumption for a current operation and a previous average power consumption, which is the average of the amount of power consumed for previous operations in order to determine required amount of power caused by the current operation according to an embodiment. Other embodiments and configurations may also be provided.

In step S500, robot 200 may perform an operation according to an embodiment, which may be referred to as an n^{th} operation. Such an operation may be repeatedly performed by robot 200 at a constant time interval.

In step S510, robot 200 may determine a current average power consumption, which is the average of the amount of power consumed in the operation by robot 200, based on the amount of power consumed in the n^{th} operation and a previous average power consumption before the end of the operation.

According to an embodiment, robot 200 may use the amount of power consumed in a current ongoing operation and the average of the amount of power required for respective operations (i.e., a previous average power consumption) in order to calculate (or determine) a battery charge amount. That is, robot 200 may determine the amount of consumed power after the current ongoing operation is terminated, and thereafter, may determine a current average power consumption to which information on the power consumption in the completed operation is added via calculation of the determined power consumption and the previous average power consumption. According to an embodiment, robot 200 may use the following Equation 1 to determine the battery charge amount.

$${E}_{n - 1} = \frac{1}{n - 1} {\sum }_{i = 1}^{n - 1} {e}_{i} , \\ {E}_{n} = \frac{1}{n} ( {E}_{n - 1} * ( n - 1 ) + {e}_{n} ) \qquad [ Equation 1 ]$$

Here, “eᵢ” refers to the amount of power consumed in an i^{th} operation, and “Eₙ₋₁” and “Eₙ” refers to an average power consumption at a time point at which n−1^{st} and n^{th} operations are completed respectively. Thus, the previous average power consumption at the time point at which the n^{th} operation is completed may be Eₙ₋₁, and the current average power consumption may be Eₙ.

According to an embodiment, robot 200 may calculate the result of Equation 1 when determining the battery charge amount. In addition to the result calculated by Equation 1, robot 200 may correct the amount of current substantially required for charging using a predetermined factor that may be calculated by the following Equation 2.

$$E = η {E}_{n} , η = \frac{{Q}_{charge}}{{Q}_{discharge}} \qquad [ Equation 2 ]$$

According to an embodiment, “Q_{charge}” may be defined as a cumulative amount of charge current, and “Q_{discharge}” may be defined as a cumulative amount of discharge current. In Equation 2, “η” may be defined as the ratio of the cumulative amount of charge current to the cumulative amount of discharge current, which are accumulated for a time period from the end of the n^{th} operation to the current time point before charging, and may be referred to as a charge factor. Through the use of such a factor, the difference between the amount of power depending on the amount of current required for charging and the amount of power substantially charged in battery 210 may be supplemented, and the result of the supplementation may be used in the subsequent determination of a charging time.

In step S520, robot 200 may determine a battery charge amount based on the current average power consumption determined in step S510 according to an embodiment. Robot 200 may determine the battery charge amount so as to correspond to the current average power consumption, and/or may process the battery charge amount via a predetermined preprocessing.

According to an embodiment, when the difference between the remaining amount of power before the implementation of an operation and a current remaining amount of power is equal to or greater than a threshold of the current average power consumption, robot 200 may determine the difference between the remaining amount of power charge before implementation of an operation and the current remaining amount of power as a battery charge amount. When robot 200 receives an instruction from the user to perform a separate operation other than a repetitive operation, robot 200 may consume more power than usual because robot 200 needs to extinguish a work load different from that of the existing operation. In this example, the remaining amount of power after the end of the operation may be slightly different from the remaining amount of power after the end of a general repetitive operation. In this example, robot 200 may charge battery 210 with the remaining amount of power immediately before the operation in order to recover battery 210 from a temporarily consumed state of power due to an additional operation to the state for the original repetitive operation.

Features of steps S530 to S550 may be the same as or similar to those of steps S420 to S440 of FIG. 4, and thus, a detailed description thereof may be omitted.

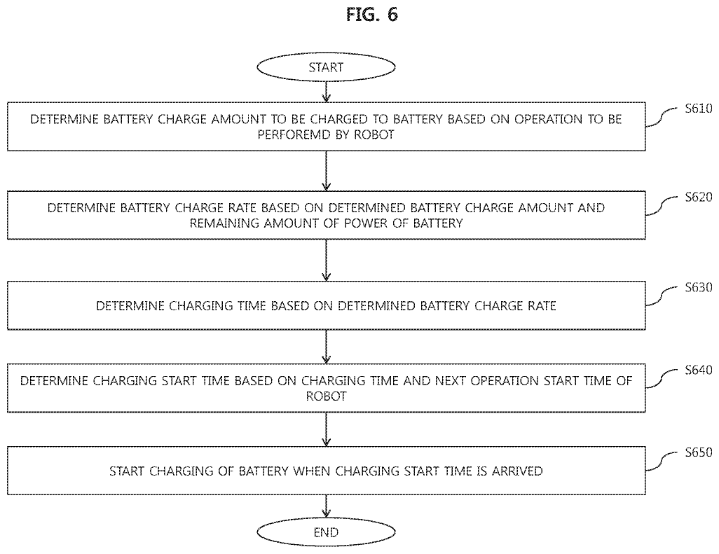

FIG. 6 is a flowchart of determining a charge rate of battery based on a battery charge amount and a remaining amount of power of battery and determining a charging time for the battery based on the determined charge rate according to an embodiment. Other embodiments and configurations may also be provided.

In step S610, robot 200 may determine a battery charge amount to be charged to the battery based on an operation to be performed by robot 200. Since the feature of step S610 may be the same as or similar to the feature of step S410 of FIG. 4, a detailed description thereof may be omitted.

In step S620, robot 200 determines a charge rate of battery 210 based on the battery charge amount determined in step S610 and the remaining amount of power of battery 210. Robot 200 may use the correlation between an open circuit voltage and the remaining amount of power in order to determine the remaining amount of power of battery 210. However, robot 200 may use various other measurement techniques to measure the remaining amount of power. According to an embodiment, robot 200 may determine the charge rate which may be applied to a charge process when charging battery 210 with the battery charge amount from the remaining amount of power. According to an embodiment, robot 200 may determine a charging profile to be used during charging based on the remaining amount of power and the battery charge amount. This may be described below in detail with reference to FIG. 7.

FIG. 7 is a graph illustrating a relationship between a charging time and the amount of power or between a charging time and an open circuit voltage OCV according to an embodiment. Other embodiments and configurations may also be provided.

Referring to FIG. 7, a relationship between the voltage or the amount of power and the charging time of battery 210 in a process in which robot 200 charges battery 210 with a battery charge amount 735 from a remaining amount of power 731a. Robot 200 may charge battery 210 using a constant voltage charge method or a constant current method. According to an embodiment, in the constant current method of charging the battery using a constant amount of current, the amount of power of battery 210 may linearly increase, but the voltage of battery 210 may tend to rapidly increase as remaining amount of power 731a is lower. According to an embodiment, in the constant voltage charge method of charging the battery using a constant voltage, the amount of power of battery 210 may tend to increase exponentially. According to an embodiment, when battery 210 is charged from a fully discharged state to a fully charged state, robot 200 may start charging by the constant current charge method, and then may change a charging profile to perform charging by the voltage potential charge method when the voltage of battery 210 has a constant value. Accordingly, robot 200 may increase the voltage of battery 210 during a constant current charge period 710 in order to supply a constant amount of charge current to battery 210 having small remaining amount of power 731a at the start of charging, and thereafter may continuously increase the voltage of battery 210 during a constant voltage charge period 720 after the voltage has increased to some extent. By using such a charge method, robot 200 may quickly charge battery 210 and may prevent battery 210 from being damaged due to a voltage difference between battery 210 and power supply unit 223.

According to an embodiment, processor 230 of robot 200 may control charging unit 220 so as to charge battery 210 only by the constant current charge method or the constant voltage charge method, and/or may control charging unit 220 so as to sequentially use the constant current charge method and the constant voltage charge method according to the magnitude of remaining amount of power 731a and battery charge amount 735. Since the charge rate of battery 210 is not constant when performing the charge process using both the constant current method and the constant voltage charge method according to an embodiment, even if the battery charge amount 735 is consistent, a charging time 730 may vary according to the magnitude of remaining amount of power 731a.

In step S630, robot 200 may determine the charging time based on the determined battery charge rate according to an embodiment.

Referring to FIG. 7, the open circuit voltage corresponding to remaining amount of power 731a is 3.6 V, and robot 200 may start charging by the constant current charge method. When the voltage rises through charging to reach a threshold voltage value (for example, 4.2 V), robot 200 may charge battery 210 by the constant voltage charge method. Robot 200 may determine the charging time required for charging the battery with battery charge amount 735 using at least one of the constant current charge method and the constant voltage charge method. For example, when robot 200 charges battery 210 using the constant current method and the constant voltage charge method, robot 200 may start charging from remaining amount of power 731a and may determine the time required for charging the battery with battery charge amount 735 in consideration of the amount of power that may be charged by the constant current charge method and the amount of power that may be charged by the constant voltage charge method. That is, in this example, the sum of the charging time of battery 210 by the constant current charge method and the charging time of battery 210 by the constant voltage charge method may be the same as the charging time 730. Robot 200 may terminate charging when charging time 730 has passed. Robot 200 may start a next operation using battery 210 having a remaining amount of power 731b and an open circuit voltage 732b.

The features of steps S640 and S650 may be the same as or similar to those of steps S430 and S440 of FIG. 4, and a detailed description thereof may be omitted.

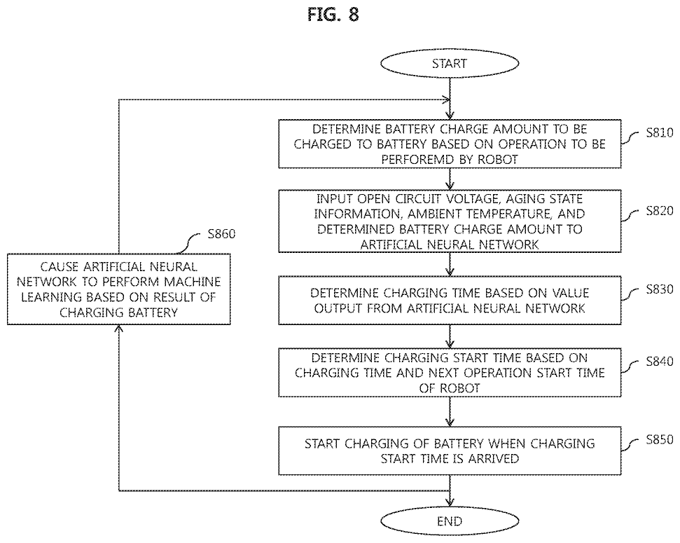

FIG. 8 is a flowchart of a battery charge method for determining a charging time suitable for an operating environment using an artificial neural network, which has performed machine learning based on a battery charging result, when the battery charge method is performed next according to an embodiment.

According to an embodiment, robot 200 may perform a predetermined information output process using an artificial neural network. According to an embodiment, the function of the artificial neural network may be implemented by driving software by processor 230, or may be implemented via a separate component (for example, a neural processing unit (NPU)) which is distinguished from processor 230.

In step S810, robot 200 may determine a battery charge amount to be charged to the battery based on an operation to be performed by robot 200 according to an embodiment. The feature of step S810 may be the same as or similar to the feature of step S410 of FIG. 4, and a detailed description thereof may be omitted.

In step S820, robot 200 may input an open circuit voltage, aging state information of battery 210, the ambient temperature of battery 210, and the battery charge amount to the artificial neural network.

According to an embodiment, the open circuit voltage as input information corresponds to the remaining amount of power of battery 210, and the artificial neural network may know the current remaining amount of power of battery 210 from the open circuit voltage input thereto.

According to an embodiment, the aging state information as input information may be the ratio of the initial remaining amount of power of battery 210 to the current remaining amount of power of battery 210. By inputting the aging state information to the artificial neural network, robot 200 may output the charging time for the substantially battery charge amount based on the aging state of battery 210, rather than outputting the charging time for a nominal increase in the amount of power (i.e., a numerical increase that may be visually checked by the user).

Information on the ambient temperature of battery 210 as input information according to an embodiment may be information for calculating the charging time optimized for an operating environment in consideration of the fact that the charge or discharge efficiency varies according to the current ambient temperature of battery 210. According to an embodiment, the ambient temperature of battery 210 with high efficiency may range from 15° C. to 35° C. The efficiency of battery 210 may be reduced in other temperature ranges. That is, in consideration of the discharge efficiency and the charge efficiency in an operating environment of robot 200, robot 200 may calculate the amount of power required for performing an operation, and may output the charging time required for charging the calculated amount of power.

In step S830, robot 200 may determine the charging time of battery 210 upon receiving output information from the artificial neural network to which the input information has been input according to an embodiment. That is, robot 200 may output the charging time depending on the operating environment of robot 200 by inputting the input information to the artificial neural network.

The features of steps S840 to S850 may be the same as or similar to those of steps S430 to S440 of FIG. 4, and thus a detailed description thereof may be omitted.

In step S860, robot 200 may cause the artificial neural network to perform machine learning based on the result of charging battery 210 according to an embodiment. That is, after the charging is started in step S850, step S860 may be performed at any time after charging is completed at a next operation start time. According to an embodiment, when the charging time is determined based on the ambient temperature of battery 210, the aging state information of 210, the remaining amount of power after completion of an operation, and the battery charge amount and the charge process is completely performed for the charging time, robot 200 may perform machine learning based on the result of the charge process. For example, when it is needed to calculate the battery charge amount again since a next operation is performed after charging is completed based on the output charging time, the artificial neural network may learn to output a more desirable charging time than that based on a previous battery charge amount. According to an embodiment, even if robot 200 acquires a relationship table indicating the correlation between the remaining amount of power and the open circuit voltage which is made in advance, robot 200 does not include the correlation in all various operating environments. Therefore, robot 200 may estimate the charging time suitable for the user's operating environment by causing the artificial neural network to perform machine learning suitable for the user's operating environment.

According to an embodiment, the battery charge amount as input information of the artificial neural network in step S820 is the amount of power that battery 210 needs to be charged until the start of a next operation. According to an embodiment, robot 200 may transmit input information preprocessed via a predetermined equation to the artificial neural network, in order to input the battery charge amount as input information to the artificial neural network.

Eₜ=E+E_{low}−E_{current} [Equation 3]

According to an embodiment, “E” may be defined as the remaining amount of power of battery 210 at a time point at which an operation is started, “E_{low}” may be defined as the minimum amount of power for stabilizing battery 210, “E_{current}” may be defined as the remaining amount of power of battery 210, and “Eₜ” may be defined as a battery charge amount that has been subjected to predetermined processing via Equation 3. According to an embodiment, robot 200 may use the battery charge amount (i.e., Eₜ) as input information of the artificial neural network.

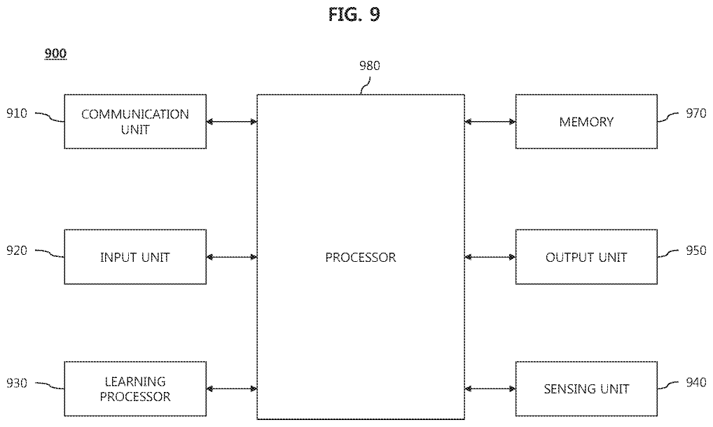

According to an embodiment, for the machine learning of the artificial neural network of robot 200, a model which performs on-line machine learning and/or a model which performs off-line machine learning using information collected on off-line may be used. Details of the features of robot 200 using the artificial neural network may be described below in detail with reference to FIGS. 9 to 11.

FIG. 9 illustrates an AI device 900 according to an embodiment of the present disclosure.

AI device 900 of FIG. 9 may correspond to mobile robot 200 of FIG. 2, and some of constituent elements of FIG. 9, which are not included in robot 200 of FIG. 2, may be selectively adopted within a range in which embodiments of the present disclosure may be realized.

AI device 900 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 9, AI device 900 may include a communication unit 910 (or communication device), an input unit 920 (or input device), a learning processor 930, a sensing unit 940 (or sensing device), an output unit 950 (or output device), a memory 970, and a processor 980, for example.

Communication unit 910 may transmit and receive data to and from external devices, such as other AI devices 1100a to 1100e and an AI server 1000, using wired/wireless communication technologies. For example, communication unit 910 may transmit and receive sensor information, user input, learning models, and control signals, for example, to and from external devices.

The communication technology used by communication unit 910 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 920 may acquire various types of data.

Input unit 920 may include a camera for the input of an image signal, a microphone for receiving an audio signal, and a user input unit for receiving information input by a user, for example. The camera or the microphone may be handled as a sensor, and a signal acquired from the camera or the microphone may be referred to as sensing data or sensor information.

Input unit 920 may acquire, for example, input data to be used when acquiring an output using learning data for model learning and a learning model. Input unit 920 may acquire unprocessed input data, and in this example, processor 980 or learning processor 930 may extract an input feature as pre-processing for the input data.

Learning processor 930 may cause a model configured with an artificial neural network to learn using the learning data. The learned artificial neural network may be called a learning model. The learning model may be used to deduce a result value for newly input data other than the learning data, and the deduced value may be used as a determination base for performing any operation.

Learning processor 930 may perform AI processing along with a learning processor 1040 of AI server 1000.

Learning processor 930 may include a memory integrated or embodied in AI device 900. Alternatively, learning processor 930 may be realized using memory 970, an external memory directly coupled to AI device 900, or a memory held in an external device.

Sensing unit 940 may acquire at least one of internal information of AI device 900, environmental information around AI device 900, and user information using various sensors.

The sensors included in sensing unit 940 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, a radar, and a temperature sensor, for example.

Output unit 950 may generate, for example, a visual output, an auditory output, or a tactile output.

Output unit 950 may include, for example, a display that outputs visual information, a speaker that outputs auditory information, and a haptic module that outputs tactile information.

Memory 970 may store data which assists various functions of AI device 900. For example, memory 970 may store input data acquired by input unit 920, learning data, learning models, and learning history, for example.

Processor 980 may determine at least one executable operation of AI device 900 based on information determined or generated using a data analysis algorithm or a machine learning algorithm. Processor 980 may control constituent elements of AI device 900 to perform the determined operation.

Processor 980 may request, search, receive, or utilize data of learning processor 930 or memory 970, and may control the constituent elements of AI device 900 so as to execute a predictable operation or an operation that is deemed desirable among the at least one executable operation.

When connection of an external device is required to perform the determined operation, processor 980 may generate a control signal for controlling the external device and may transmit the generated control signal to the external device.

Processor 980 may acquire intention information with respect to user input and may determine a user request based on the acquired intention information.

Processor 980 may acquire intention information corresponding to the user input using at least one of a speech to text (STT) engine for converting voice input into a character string and a natural language processing (NLP) engine for acquiring natural language intention information.

At least a part of the STT engine and/or the NLP engine may be configured with an artificial neural network learned according to a machine learning algorithm. The STT engine and/or the NLP engine may have learned by learning processor 930, may have learned by learning processor 1040 of AI server 1000, or may have learned by distributed processing of these processors.

Processor 980 may collect history information including, for example, the content of an operation of AI device 900 or feedback of the user with respect to an operation, and may store the collected information in memory 970 or learning processor 930, or may transmit the collected information to an external device such as AI server 1000. The collected history information may be used to update a learning model.

Processor 980 may control at least some of the constituent elements of AI device 900 in order to drive an application program stored in memory 970. Moreover, processor 980 may combine and operate two or more of the constituent elements of AI device 900 for the driving of the application program.

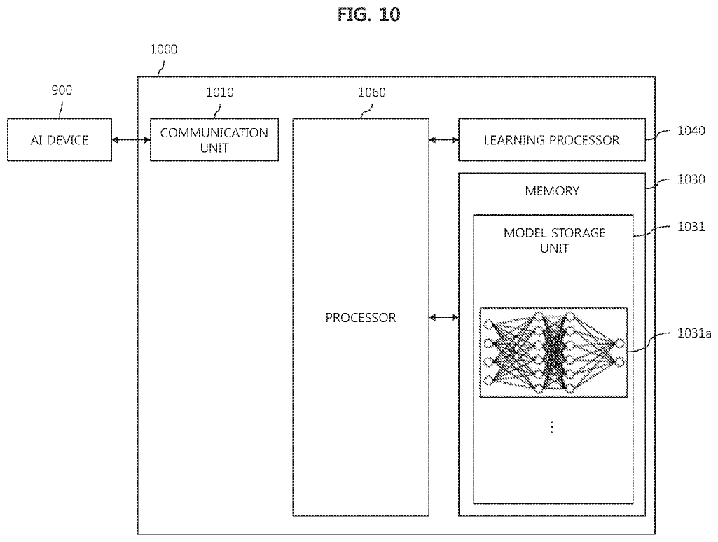

FIG. 10 illustrates AI server 1000 according to an embodiment of the present disclosure.

Referring to FIG. 10, AI server 1000 may refer to a device that causes an artificial neural network to learn using a machine learning algorithm or uses the learned artificial neural network. AI server 1000 may be constituted of multiple servers to perform distributed processing, and may be defined as a 5G network. AI server 1000 may be included as a constituent element of AI device 900 so as to perform at least a part of AI processing together with the AI device.

AI server 1000 may include a communication unit 1010 (or communication device), a memory 1030, learning processor 1040, and a processor 1060, for example.

Communication unit 1010 may transmit and receive data to and from an external device such as AI device 900.

Memory 1030 may include a model storage unit 1031. Model storage unit 1031 may store a model (or an artificial neural network) 1031a which is learning or has learned via learning processor 1040.

Learning processor 1040 may cause artificial neural network 1031a to learn learning data. A learning model may be used in the state of being provided (or mounted) in AI server 1000 of the artificial neural network, or may be used in the state of being mounted in an external device such as AI device 900.

The learning model may be realized in hardware, software, or a combination of hardware and software. When a part or the entirety of the learning model may be realized in software, one or more instructions constituting the learning model may be stored in memory 1030.

Processor 1060 may deduce a result value for newly input data using the learning model, and may generate a response or a control instruction based on the deduced result value.

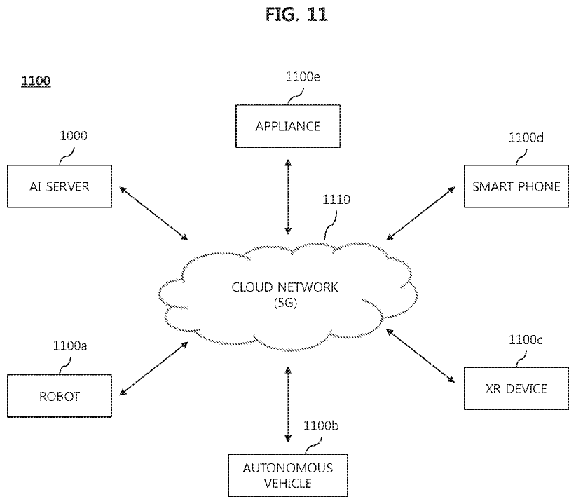

FIG. 11 illustrates an AI system 1100 according to an embodiment of the present disclosure.

Referring to FIG. 11, in AI system 1100, at least one of AI server 1000, a robot 1100a, an autonomous vehicle 1100b, an XR device 1100c, a smart phone 1100d, and a home appliance 1100e is connected to a cloud network 1110. Robot 1100a, autonomous vehicle 1100b, XR device 1100c, smart phone 1100d, and home appliance 1100e, to which AI technologies are applied, may be referred to as AI devices 1100a to 1100e.

Cloud network 1110 may constitute a part of a cloud computing infra-structure, or may refer to a network present in the cloud computing infra-structure. Cloud network 1110 may be configured using a 3G network, a 4G or long term evolution (LTE) network, or a 5G network, for example.

That is, respective devices 1100a to 1100e and 1000 constituting AI system 1100 may be connected to each other via cloud network 1110. In particular, respective devices 1100a to 1100e and 1000 may communicate with each other via a base station, or may perform direct communication without the base station.

AI server 1000 may include a server which performs AI processing and a server which performs an operation with respect to big data.

AI server 1000 may be connected to at least one of robot 1100a, autonomous vehicle 1100b, XR device 1100c, smart phone 1100d, and home appliance 1100e, which are AI devices constituting AI system 1100, via cloud network 1110, and may assist at least a part of AI processing of connected AI devices 1100a to 1100e.

Rather than AI devices 1100a to 1100e, AI server 1000 may cause an artificial neural network to learn according to a machine learning algorithm, and may directly store a learning model or may transmit the learning model to AI devices 1100a to 1100e.

AI server 1000 may receive input data from AI devices 1100a to 1100e, may deduce a result value for the received input data using the learning model, and may generate a response or a control instruction based on the deduced result value to transmit the response or the control instruction to AI devices 1100a to 1100e.

Alternatively, AI devices 1100a to 1100e may directly deduce a result value with respect to input data using the learning model, and may generate a response or a control instruction based on the deduced result value.

Various embodiments of AI devices 1100a to 1100e, to which the above-described technology is applied, may be described. AI devices 1100a to 1100e shown in FIG. 11 may be specific embodiments of AI device 900 shown in FIG. 9.

Robot 1100a may be realized into a guide robot, a transportation robot, a cleaning robot, a wearable robot, an entertainment robot, a pet robot, or an unmanned flying robot, for example, through application of AI technologies.

Robot 1100a may include a robot control module for controlling an operation, and the robot control module may refer to a software module or a chip realized in hardware.

Robot 1100a may acquire information on the state of robot 1100a using sensor information acquired from various types of sensors, may detect (recognize) the surrounding environment and an object, may generate map data, may determine a movement route and a driving plan, may determine a response with respect to user intersection, or may determine an operation.

Robot 1100a may use sensor information acquired from at least one sensor among a lidar, a radar, and a camera in order to determine a movement route and a driving plan.

Robot 1100a may perform the above-described operations using a learning model configured with at least one artificial neural network. For example, robot 1100a may recognize the surrounding environment and the object using the learning model, and may determine an operation using the recognized surrounding environment information or object information. The learning model may be directly learned in robot 1100a, or may be learned in an external device such as AI server 1000.

Robot 1100a may directly generate a result using the learning model to perform an operation, but may transmit sensor information to an external device such as AI server 1000 and receive a result generated by the external device to perform an operation.

Robot 1100a may determine a movement route and a driving plan using at least one of map data, object information detected from sensor information, and object information acquired from an external device, and a drive unit may be controlled to drive robot 1100a according to the determined movement route and driving plan.

The map data may include object identification information for various objects arranged in a space along which robot 1100a moves. For example, the map data may include object identification information for stationary objects, such as the wall and the door, and movable objects such as a flowerpot and a desk. The object identification information may include names, types, distances, and locations, for example.

Additionally, robot 1100a may perform an operation or may drive by controlling the drive unit based on user control or interaction. Robot 1100a may acquire interactional intention information depending on a user operation or voice expression, and may determine a response based on the acquired intention information to perform an operation.

Autonomous vehicle 1100b may be realized into a mobile robot, a vehicle, or an unmanned air vehicle, for example, through application of AI technologies.

Autonomous vehicle 1100b may include an autonomous driving control module for controlling an autonomous driving function, and the autonomous driving control module may mean a software module or a chip realized in hardware. The autonomous driving control module may be a constituent element included in autonomous vehicle 1100b, but may be a separate hardware element outside autonomous vehicle 1100b so as to be connected thereto.

Autonomous vehicle 1100b may acquire information on the state of autonomous vehicle 1100b using sensor information acquired from various types of sensors, may detect (recognize) the surrounding environment and an object, may generate map data, may determine a movement route and a driving plan, or may determine an operation.

Autonomous vehicle 1100b may use sensor information acquired from at least one sensor among a lidar, a radar, and a camera in the same manner as robot 1100a in order to determine a movement route and a driving plan.

Autonomous vehicle 1100b may recognize the environment or an object with respect to an area outside the field of vision or an area located at a predetermined distance or more by receiving sensor information from external devices, or may directly receive recognized information from external devices.

Autonomous vehicle 1100b may perform the above-described operations using a learning model configured with at least one artificial neural network. For example, autonomous vehicle 1100b may recognize the surrounding environment and the object using the learning model, and may determine a driving line using the recognized surrounding environment information or object information. The learning model may be directly learned in autonomous vehicle 1100b, or may be learned in an external device such as AI server 1000.

Autonomous vehicle 1100b may generate a result using the learning model to perform an operation, but may transmit sensor information to an external device such as AI server 1000 and receive a result generated by the external device to perform an operation.

Autonomous vehicle 1100b may determine a movement route and a driving plan using at least one of map data, object information detected from sensor information, and object information acquired from an external device, and a drive unit may be controlled to drive autonomous vehicle 1100b according to the determined movement route and driving plan.

The map data may include object identification information for various objects arranged in a space (e.g., a road) along which autonomous vehicle 1100b drives. For example, the map data may include object identification information for stationary objects, such as streetlights, rocks, and buildings, and movable objects such as vehicles and pedestrians. The object identification information may include names, types, distances, and locations, for example.

Autonomous vehicle 1100b may perform an operation or may drive by controlling the drive unit based on user control or interaction. Autonomous vehicle 1100b may acquire interactional intention information depending on a user operation or voice expression, and may determine a response based on the acquired intention information to perform an operation.

XR device 1100c may be realized into a head-mount display (HMD), a head-up display (HUD) provided in a vehicle, a television, a cellular phone, a smart phone, a computer, a wearable device, a home appliance, a digital signage, a vehicle, a stationary robot, or a mobile robot, for example, through application of AI technologies.

XR device 1100c may obtain information on the surrounding space or a real object by analyzing three-dimensional point cloud data or image data acquired from various sensors or an external device to generate positional data and attribute data for three-dimensional points, and may output an XR object by rendering the XR object to be output. For example, XR device 1100c may output an XR object including additional information about a recognized object so as to correspond to the recognized object.

XR device 1100c may perform the above-described operations using a learning model configured with at least one artificial neural network. For example, XR device 1100c may recognize a real object from three-dimensional point cloud data or image data using a learning model, and may provide information corresponding to the recognized real object. The learning model may be directly learned in XR device 1100c, or may be learned in an external device such as AI server 1000.

XR device 1100c may directly generate a result using the learning model to perform an operation, but may transmit sensor information to an external device such as AI server 1000 and receive the generated result to perform an operation.

Robot 1100a may be realized into a guide robot, a transportation robot, a cleaning robot, a wearable robot, an entertainment robot, a pet robot, or an unmanned flying robot, for example, through application of AI technologies and autonomous driving technologies.

Robot 1100a to which the AI technologies and the autonomous driving technologies are applied may refer to, for example, a robot having an autonomous driving function, or may refer to robot 1100a which interacts with autonomous vehicle 1100b.

Robot 1100a having an autonomous driving function may collectively refer to devices that move by themselves along a given moving line without user control, or move by determining a moving line by themselves.

Robot 1100a and autonomous vehicle 1100b, which have an autonomous driving function, may use a common sensing method in order to determine at least one of a movement route or a driving plan. For example, robot 1100a and autonomous vehicle 1100b, which have an autonomous driving function, may determine at least one of the movement route or the driving plan using information sensed by a lidar, a radar, and a camera.

Robot 1100a, which interacts with autonomous vehicle 1100b, may be provided separately from autonomous vehicle 1100b so as to be connected to the autonomous driving function of autonomous vehicle 1100b inside or outside autonomous vehicle 1100b, or may perform an operation associated with a user who has got on autonomous vehicle 1100b.

Robot 1100a, which interacts with autonomous vehicle 1100b, may acquire sensor information instead of autonomous vehicle 1100b to provide the information to autonomous vehicle 1100b, or may acquire sensor information and generate surrounding environment information or object information to provide the information to autonomous vehicle 1100b, thereby controlling or assisting the autonomous driving function of autonomous vehicle 1100b.

Alternatively, robot 1100a, which interacts with autonomous vehicle 1100b, may monitor the user who has got on autonomous vehicle 1100b or may control the functions of autonomous vehicle 1100b via interaction with the user. For example, when it is determined that a driver is in a drowsy state, robot 1100a may activate the autonomous driving function of autonomous vehicle 1100b or may assist the control of a drive unit of autonomous vehicle 1100b. The functions of autonomous vehicle 1100b controlled by robot 1100a may include not only the autonomous driving function, but also a function provided in a navigation system or an audio system provided in autonomous vehicle 1100b.

Alternatively, robot 1100a, which interacts with autonomous vehicle 1100b, may provide information to autonomous vehicle 1100b or assist the function thereof at the outside of autonomous vehicle 1100b. For example, robot 1100a may serve as a smart traffic light that provides traffic information including, for example, traffic signal information to autonomous vehicle 1100b, or may serve as an automatic electric charging unit of an electric vehicle that may interact with autonomous vehicle 1100b and may be automatically connected to a charge port of the vehicle.

Robot 1100a may be realized into a guide robot, a transportation robot, a cleaning robot, a wearable robot, an entertainment robot, a pet robot, an unmanned flying robot, or a drone, for example, through the application of AI technologies and XR technologies.

Robot 1100a, to which the XR technologies are applied, may refer to a robot which is a control or interaction target in an XR image. In this example, robot 1100a may be provided separately from XR device 1100c and may operate in cooperation with XR device 1100c.

When robot 1100a, which is a control or interaction target in an XR image, acquires sensor information from sensors including a camera, robot 1100a or XR device 1100c may generate an XR image based on the sensor information, and XR device 1100c may output the generated XR image. Such robot 1100a may operate based on a control signal input through XR device 1100c or via intersection with the user.

For example, the user may check the XR image corresponding to the viewpoint of robot 1100a, which is remotely linked, via an external device such as XR device 1100c, and may adjust an autonomous driving route of robot 1100a or control an operation or driving thereof via interaction with the robot, or may check information on an object around thereof.

Autonomous vehicle 1100b may be realized into a mobile robot, a vehicle, or an unmanned air vehicle, for example, through application of the AI technologies and the XR technologies.

Autonomous vehicle 1100b, to which the XR technologies are applied, may refer to an autonomous vehicle having an XR image providing device, or may refer to an autonomous vehicle as a control or interaction target in an XR image, for example. More particularly, autonomous vehicle 1100b as a control or interaction target in an XR image may be provided separately from XR device 1100c and may operate in cooperation with XR device 1100c.

Autonomous vehicle 1100b having the XR image providing device may acquire sensor information from sensors including a camera, and may output an XR image generated based on the acquired sensor information. For example, autonomous vehicle 1100b may include an HUD to output an XR image, thereby providing an occupant with an XR object corresponding to a real object or an object in the screen.

When the XR object is output to the HUD, at least a portion of the XR object may be output so as to overlap with a real object to which the passenger's gaze is directed. On the other hand, when the XR object is output to a display provided in autonomous vehicle 1100b, at least a portion of the XR object may be output so as to overlap with an object in the screen. For example, autonomous vehicle 1100b may output XR objects corresponding to objects such as a lane, another vehicle, a traffic light, a traffic sign, a two-wheeled vehicle, a pedestrian, and a building.

When autonomous vehicle 1100b as a control or interaction target in an XR image acquires sensor information from sensors including a camera, autonomous vehicle 1100b or XR device 1100c may generate an XR image based on the sensor information, and XR device 1100c may output the generated XR image. A autonomous vehicle 1100b may operate based on a control signal input through an external device such as XR device 1100c or via interaction with the user.

The above-described battery charge method according to the present disclosure may be provided as a program to be executed in a computer and may be recorded on a computer readable recording medium.

The battery charge method according to the present disclosure may be executed via software. When executed via software, constituent elements of the present disclosure are code segments that execute required operations. The program or the code segments may be stored in a processor readable medium.

The computer readable recording medium includes all kinds of recording devices in which data is stored in a computer readable manner. Examples of the computer readable recording device include a ROM, a RAM, a CD-ROM, a DVD-ROM, a DVD-RAM, a magnetic tape, a floppy disc, a hard disc, and an optical data storage device. In addition, the computer readable recording medium may be distributed in a computer device connected thereto via a network so that a computer readable code may be stored and executed in a distribution manner.

The present disclosure is devised to increase the lifespan of a secondary battery included in a robot by minimizing the rate of aging of the battery due to charge and discharge processes in order to reduce the user's burden on the replacement cost of the battery.

The present disclosure is devised to enable a robot to efficiently perform a charge process only for a time effective for the prevention of aging of a battery while the robot is not operating in order not to substantially disturb an operation of the robot.

The present disclosure is devised to calculate, through the use of artificial intelligence, the time substantially required for charging in an environment in which a robot performs an operation, and accordingly, provide the most efficient battery charge method for the operating environment of the robot.

In order to address the above-described technical solutions, according to one embodiment, there is provided a method of charging a battery included in a robot, the method including determining a battery charge amount to be charged to the battery based on an operation to be performed by the robot, determining a charging time for the battery based on the determined battery charge amount, determining a charging start time based on the charging time and a next operation start time of the robot, and starting charging of the battery when the charging start time is arrived

In order to solve the above-described technical solutions, according to one embodiment, there is provided a robot that performs an operation, the robot including a rechargeable battery, a charging unit configured to charge the battery upon receiving power, and a processor configured to determine a battery charge amount to be charged to the battery based on an operation to be performed by the robot, determine a charging time for the battery based on the determined battery charge amount, determine a charging start time based on the charging time and a next operation start time of the robot, and control the charging unit to start charging of the battery when the charging start time is arrived.

In order to solve the above-described technical solutions, according to one embodiment, there is provided a non-transitory computer readable recording medium including a computer program for performing a method of charging a battery.

In order to solve the above-described technical solutions, according to one embodiment, there is provided a method of charging a battery included in a robot, the method including terminating, by the robot, an operation that the robot has performed, and moving to a charging station, waiting, by the robot, for a predetermined time after moving to the charging station, and charging, by the robot, the battery of the robot upon receiving power via the charging station after the predetermined time has passed.

According to an embodiment of the present disclosure, it is possible to prevent the situation in which a battery is charged beyond a required amount of power for an operation in an operating environment in which the battery is repeatedly charged and discharged, thereby preventing unnecessary power consumption.

In addition, according to an embodiment of the present disclosure, it is possible to charge a battery with only a required amount of power that is expected to be required for an operation, instead of charging the battery to a fully charged state, thereby reducing the rate of aging of the battery.

In addition, according to an embodiment of the present disclosure, it is possible to adopt an optimal charge method depending on the state of a battery by determining a charging time in consideration of the amount of power required for a next operation for each remaining amount of power at the time of starting charging, thereby reducing the rate of aging of the battery.

In addition, according to an embodiment of the present disclosure, it is possible to output a charging time optimized for an operating environment or the state of a battery, for example, by inputting predetermined information, which may be obtained during repeated charge and discharge processes, to an artificial neural network, which has machine-learned, and perform charging for the charging time. Thereafter, by causing the artificial neural network to again perform machine learning according to the result of charging, it is possible to output a charging time optimized for each of various operating environments that a robot may encounter. Therefore, it is possible to perform a process of determining a charging time adaptive to an operating environment, rather than determining a standardized charging time.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of charging a battery for powering a robot, the method comprising:
determining a battery charge amount to be charged to the battery based on an operation to be performed by the robot;
determining a charging time for the battery based on the determined battery charge amount;
determining a charging start time based on a next operation start time of the robot and the determined charging time; and
starting charging of the battery at the determined charging start time.

2. The method of claim 1, wherein the determining of the charging start time includes determining, as the charging start time, a time point that is prior to the next operation start time by an amount of time corresponding to the charging time.

3. The method of claim 1, wherein the determining of the battery charge amount includes:
after a previous operation, determining a current average power consumption based on an amount of power consumed in the previous operation and a previous average power consumption before the end of the previous operation; and
determining the battery charge amount based on the current average power consumption.

4. The method of claim 3, wherein the determining of the battery charge amount includes:
determining a predetermined factor based on a cumulative amount of charge current and a cumulative amount of discharge current of the robot; and
determining the battery charge amount by changing the current average power consumption based on the predetermined factor.

5. The method of claim 1, wherein the determining of the charging time includes:
determining a battery charge rate based on the determined battery charge amount and a remaining amount of power of the battery; and
determining the charging time based on the determined battery charge rate.

6. The method of claim 5, wherein the determining of the battery charge rate includes determining the charge rate based on a charging profile available for charging of the battery charge amount from the remaining amount of power of the battery,
wherein the charging profile includes a constant current charge or a constant voltage charge.

7. The method of claim 1, wherein the determining of the charging time for the battery includes determining the charging time output when inputting, to an artificial neural network, input information that includes an open circuit voltage, aging state information of the battery, an ambient temperature, and the determined battery charge amount,
wherein the artificial neural network is to perform machine learning based on the input information obtained in a repetitive charge process of the robot, and
wherein the determined battery charge amount is changed based on a minimum amount of power for stabilization of the battery, and the battery charge amount is then input as the input information to the artificial neural network.

8. A non-transitory computer readable recording medium comprising a computer program for performing the method of claim 1.

9. A robot that performs an operation, the robot comprising:
a rechargeable battery;
a charging device configured to charge the battery; and
a processor configured to:
determine a battery charge amount to be charged to the battery based on an operation to be performed by the robot,
determine a charging time for the battery based on the determined battery charge amount,
determine a charging start time based on a next operation start time of the robot and the determined charge time, and
control the charging device to start charging the battery at the determined charging start time.

10. The robot of claim 9, wherein the processor is configured to determine, as the charging start time, a time point that is prior to the next operation start time by an amount of time corresponding to the charging time.

11. The robot of claim 9, wherein the processor is configured to:
determine, after a previous operation, a current average power consumption based on an amount of power consumed in the previous operation and a previous average power consumption before the end of the previous operation, and
determine the battery charge amount based on the current average power consumption.

12. The robot of claim 11, wherein the processor is configured to:
determine a predetermined factor based on a cumulative amount of charge current and a cumulative amount of discharge current of the robot, and
determine the battery charge amount by changing the current average power consumption based on the predetermined factor.

13. The robot of claim 9, wherein the processor is configured to:
determine a battery charge rate based on the determined battery charge amount and a remaining amount of power of the battery, and
determine the charging time based on the determined battery charge rate.

14. The robot of claim 13, wherein the processor is configured to determine the battery charge rate based on a charging profile available for charging of the battery charge amount from the remaining amount of power of the battery,
wherein the charging profile includes a constant current charge or a constant voltage charge.

15. The robot of claim 9, wherein the processor is configured to determine the charging time output when inputting, to an artificial neural network, input information that includes an open circuit voltage, aging state information of the battery, an ambient temperature, and the determined battery charge amount,
wherein the artificial neural network is to perform machine learning based on the input information obtained in a repetitive charge process of the robot, and
wherein the determined battery charge amount is charged based on a minimum amount of power for stabilization of the battery, and the battery charge amount is then input as the input information to the artificial neural network.

16. A method of charging a battery for powering a robot, the method comprising:
terminating, by the robot, an operation that the robot has performed, and moving the robot to a charging station;
waiting, by the robot, for a predetermined time after the robot is moved to the charging station; and
charging, the battery of the robot upon receiving power via the charging station after the predetermined time has passed since the robot moved to the charging station.

17. The method of claim 16, wherein the waiting for the predetermined time includes:
determining the predetermined time based on a battery charging time determined based on a battery charge amount to be charged to the battery based on an operation to be performed by the robot; and
waiting for the predetermined time since the robot moved to the charging station.

18. The method of claim 17, wherein the determining the predetermined time includes determining the predetermined time based on the battery charging time and an operation start time at which the operation is started.

19. The method of claim 16, wherein the waiting for the predetermined time includes waiting for the predetermined time while charging the battery with a smaller amount of power than an amount of power supplied in the charging of the battery.

20. The method of claim 16, wherein the waiting for the predetermined time includes waiting for the predetermined time without charging the battery.
